(19) United States
(12) Patent Application Publication
(10) Pub. No.: US 2005/0167508 A1
(43) Pub. Date: Aug. 4, 2005

(54) Microengineered optical scanner

(76) Inventors: Richard Syms, London (GB); Andrew Holmes, London (GB)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/516,811

(22) PCT Filed: Jun. 2, 2003
(86) PCT No.: PCT/GB03/02397

(30) Foreign Application Priority Data
Jun. 7, 2002 (GB) 0213008.6

(51) Int. Cl. G06K 7/10

(52) U.S. Cl. 235/473

(57) ABSTRACT

A microengineered optical scanner based on a moving cantilevered dielectric waveguide is described. The waveguide is excited into resonant mechanical motion by a drive located at its root. Stress sensors detect the bending of the waveguide, allowing closed loop control of the motion. A moving image of the light emitted from the moving tip of the waveguide is created by a lens. The moving image acts as a scan line. Light back-scattered from a rough surface placed at the image plane is collected back into the waveguide by confocal imaging. The light collected in the cladding of the waveguide has higher numerical aperture than the light collected in the core. The cladding light is detected by a mode-stripping detector. Techniques for combining a cantilevered waveguide, a drive, motion sensors and a mode-stripping detector using microelectromechanical systems (MEMS) technology are described.

### FIELD OF THE INVENTION

The invention relates to optical scanners and in particular to a microengineered optical scanner or optical reading device and methods for making such a device.

### BACKGROUND

Bar code readers and scanners are optical information gathering systems. They operate by sweeping a point image through a set of trajectories and using confocal detection to collect light back-scattered from objects present in the focal plane. In a point-of-sales (POS) application, the object is a coded bar pattern, which provides brand and category information on an item to be sold. Other applications include inventory control and video programming. In many of these applications, it is important that the scanners be portable and lightweight, and allow hands-free operation. There is therefore a strong incentive to reduce their size and cost.

There are several methods of generating the scan line in a bar code reader. A static point image may be created, simply by using a lens to form a real image of a point source. Alternatively, a curved, focusing mirror may be used. This image may be converted into a dynamic image by moving one of the components in the system. Scanning by motion of the source (100), with a lens (105) held fixed, generates a continuous scan line (110), as shown in FIG. 1a. Scanning by selecting one of a number of discrete sources (115) generates a discrete scan line (120), as shown in FIG. 1b.

Scanning by moving the lens again generates a continuous scan line, as shown in FIG. 1c. In this case, an array of lenses (125) is often swept past the source (130) in sequence. The lenses may be constructed as an arrangement of flat, holographic elements on a disc, which is then rotated to provide the necessary lens motion.

The scanner types described above are known as ‘pre-objective’ scanners, since they exploit the motion of an object in front of an objective lens. An alternative group are known as ‘post-objective’ scanners. These involve deflection of the beam by a mirror (135) after the imaging system, as shown in FIG. 1d. The beam may be deflected by rotation of a polygonal mirror, or a mirror mounted on an elastic torsion suspension. Torsion mirrors are often resonant vibrating devices.

The signal is obtained from back-scattered light. To obtain sufficient signal strength, the back-scattered beam must normally be of considerably higher numerical aperture than the illuminating beam. To reject ambient light and signals from de-focused objects, confocal detection is often used. This method may be implemented using an additional beam-splitter (140), pinhole (145) and photodiode (150) as shown in FIG. 1e. Clearly the position of components such as the beam-splitter and photodiode must remain fixed relative to the source if the detected signal is to track the scanned image point. This requirement can easily be satisfied using fixed component positions in moving lens or moving mirror systems. It is harder to satisfy in a moving source system.

A number of the techniques described above have been miniaturised using micro-electro-mechanical systems (MEMS) technology. This method involves the use or adaptation of semiconductor processing to form a variety of structures and devices in addition to conventional electronic components. Often the materials are silicon and its compatible oxides. Examples of micro-electro-mechanical systems include mechanical, thermal, fluidic, chemical, biochemical, electrical and optical systems.

A number of MEMS based scanners have been described or constructed. However, the vast majority lack any appropriate signal detection, and are therefore not true reading systems. For example U.S. Pat. No. 5,734,490, describes the construction of a MEMS scanner as a moving lens systems. MEMS-based polygonal scanners have also been constructed by using deep reactive ion etching to create mirror surfaces that lie normal to the substrate.

However, the overwhelming emphasis has been to use shallower etching methods to create mirror surfaces that lie parallel to the substrate. These have been implemented as single-axis torsion mirror scanners such as that described in U.S. Pat. No. 4,317,611 and also as two-axis devices as described in U.S. Pat. No. 5,629,790. Alternatively as described in EP 0 875 780, MEMS mirror scanners have used beam bending rather than torsion. Two-axis vibrating beam scanners have also been demonstrated in patents such as U.S. Pat. No. 5,097,354 and U.S. Pat. No. 5,444,565, which also have incorporated signal detection.

The most complicated MEMS moving mirror scanners have used surface micro-machining methods to create sets of flat parts. The parts are subsequently rotated out of plane and interlocked to form fully 3D structures. Such a device is disclosed by Syms R. R. A. “Operation of a surface-tension self-assembled 3-D micro-optomechanical torsion mirror scanner” Elect. Lett. 35, 1157-1158 (1999).

MEMS-based moving source scanners have received less attention, because of the difficulty of constructing a suitable confocal detection system.

The principle of optical scanning by vibrating a cantilevered fibre and the application of an optical fibre receiver to a bar code reader have both been described in patents such as U.S. Pat. No. 5,404,001, U.S. Pat. No. 5,422,469 and U.S. Pat. No. 5,521,367. FIG. 2a shows the former process. A length of fibre (205) is mounted so that a short section protrudes from an anchor point (210). This section may be excited into mechanical oscillation using a cantilever (215) at the resonant frequency for bending mode vibrations. Laser light (200) injected into the fixed left-hand end will then emerge from the moving right-hand end to form an illuminating beam (230). The moving source thus created is then imaged onto the bar code (240) by a lens (220). FIG. 2b shows the latter process. Back-scattered light (233) from the bar code is coupled back into the fibre (205), and passed to a detector (255) by a beam splitter (245). An optical fibre coupler (250) may be used instead of the beam splitter as shown in FIG. 2c.

The light that is transmitted by a dielectric waveguide (300), such as an optical fibre, is guided by total internal reflection at the interface (325) between the central core (305) and the surrounding cladding material (310), as shown in FIG. 3a. Because the refractive indices of the core and cladding are normally quite similar, total internal reflection only occurs when the light rays strike the core-cladding interface at a shallow angle. The light emerging from the end facet (315) of a single-mode optical fibre therefore has a very low numerical aperture (NA), and forms a narrow cone of radiation. After magnification by a lens, as shown in FIG. 4, the cone of radiation falling on the bar code has an even smaller NA. This can be advantageous for scanning, since it results in a large depth of focus. However, it results in a low detected signal, because only a small fraction of the available back-scattered light is collected. The useful range of a bar code reader constructed in this way is therefore small.

The light that is guided in the cladding of the optical fibre may have a much larger numerical aperture, since the difference in refractive indices of the cladding and the surround (air) at that interface (330) is normally much greater. In principle, a much larger fraction of the back-scattered light (320) may therefore be gathered if it is coupled into the cladding of the fibre as shown in FIG. 3b. The cladding mode light may be extracted from the fibre by, for example, cementing the fibre to a slab (340) using an index-matched epoxy (335), as shown in FIG. 3c. The slab may be a detector element, allowing direct detection of the cladding mode light.

This principle allows a confocal system to be constructed with different numerical apertures for the illuminating beam and the received signal, as shown in FIG. 4. Here the illuminating beam (410) is derived from the guided mode of a single-mode optical fibre (300), and forms a low numerical aperture beam that is imaged by the lens (400) onto the surface (405) to be scanned. The received signal (415) is collected by the same lens and coupled into the cladding modes of the same fibre. Some light is necessarily coupled back into the guided mode, but this represents a small fraction of the total. The cladding mode light may be conveniently separated from the guided mode using a mode-stripping detector as described earlier, without the need for an additional beam splitter.

A fibre-based dual numerical aperture bar code reader operating in this way has previously been described by the present inventors in Roberts D. A., Syms R. R. A., Holmes A. S., Yeatman E. M. “Dual numerical aperture confocal operation of a moving fibre Bar code reader” Elect. Lett. 35, 1656-1658 (1999), and Roberts D. A., Syms R. R. A. “1D and 2D laser line scan generation using a fibre optic resonant scanner” SPIE Proc. 4075, 62-73 (2000). It was shown that the improvement in signal collection efficiency allowed a considerable increase in the range over which the system could be operated, compared with a comparable system based on collection of back-scattered light into the guided mode.

However it was also shown that the magnification of the lens has a significant effect on performance and that the requirements on magnification for detection and scanning are therefore in conflict.

Two types of MEMS actuators are common; those based on electrostatic operation and those based on electrothermal operation. Typical MEMS electrostatic actuators (500) consist of either parallel or interdigitated electrodes (520), such as those shown in FIG. 5a. Each type may be formed by etching a pattern into an electrically-isolated silicon or poly-silicon layer. The layer may then be metallised to improve its conductivity. Application of a voltage from a voltage source (505) to two anchors (510a) coupled to the electrodes then gives rise to an attractive electrostatic force. Interdigitated electrodes typically offer greater capacitance, and hence greater force, in a given chip area. Application of a voltage between the electrodes results in an electrostatic force, which deflects the cantilever laterally until the elastic force of the cantilever balances the electrostatic force.

MEMS electrothermal actuators typically consist of buckling mode devices and bimorphs, and examples are shown in FIGS. 5b and 5c. A current is passed through a beam (525) that is suspended between two anchor points (510b, 510c). Constrained thermal expansion results in an axial force, which buckles the beam laterally when the first Euler critical load is reached. The force obtained can be increased, by using a set of actuators arranged in parallel. The direction of buckling (which is indeterminate in the symmetric system shown) may be preferentially determined by using a pre-buckled beam shape or an eccentric load.

Electrothermal bimorphs can be divided into two types, based on differences in material and shape, respectively. The former requires additional layers of material. FIG. 5c shows an example of the latter. A folded beam, having a hot arm (530) and a cold arm (540) is suspended between two anchors (510c). The beam has a variable cross-sectional width, being narrower on average in one of the two arms (the hot arm) than the other (the cold arm). When a current is passed between the anchors, the hot arm is preferentially heated and therefore expands more. Differential thermal expansion then deflects the structure laterally. A flexure (580) is placed at the root of the cold arm (540) to allow motion. Similar behaviour can be obtained using unequal arm lengths, or a doubled hot arm.

MEMS actuators typically provide only small displacements.

Much larger displacements may be obtained by coupling the actuator (560) to a resonator (565), such as a long cantilever as shown in FIG. 5d. Out-of-plane actuators have been constructed in this way using material bimorphs, and in-plane actuators have been constructed using shape bimorphs such as those described in Syms R. R. A. “Long-travel electrothermally-driven resonant cantilever microactuators” J. Micromech. Microeng. 12, 211-218 (2002)).

The actuator consists of a long cantilever coupled to an electrothermal drive and lateral displacements of 0.5 mm were obtained at low powers when the resonant frequency of the cantilever was appropriately matched to the bandwidth of the transducer, and when the cantilever was sufficiently massive to obtain a resonance with high quality factor. This displacement has been shown to be sufficient for bar code reading applications.

Despite these advances, little progress has been made in developing an integrated pre-objective scanner. There is therefore a need to provide a device that meets the performance requirements of a bar code reader yet can be provided in a MEMS environment.

It is an object of the present invention to provide such a device and a method of manufacturing same.

### SUMMARY OF THE INVENTION

Accordingly the present invention provides a Bar code reader device or scanner fabricated using silicon-based micro-electro-mechanical systems (MEMS) technology.

In accordance with a preferred embodiment of the invention an optical reading device is provided having a light source, a movable optical waveguide, an actuator, a detector. The actuator and detector are desirably integrally formed in a substrate, the movement of the waveguide being effected by action of the actuator thereon.

Typically the device further includes motion sensors such that any movement of the waveguide is detectable by the motion sensors.

The optical waveguide is desirably formed as an integrated channel guide formed in dielectric materials and surrounded by a cladding of restricted lateral dimensions.

Alternatively, the waveguide may be externally attached or coupled to the device.

Typically, the optical waveguide is single-moded and polarization-preserving.

Preferably, the source is polarized and arranged to excite a single polarization mode of the waveguide.

In a preferred embodiment the optical waveguide is constructed on a suspended cantilever above a substrate. In a first embodiment the waveguide is supported by a mechanical layer along its entire length. In an alternative embodiment the waveguide is supported only near its root by a mechanical layer.

Desirably the substrate provides a mechanical layer, and is typically a silicon based layer. In one embodiment the detector is constructed in the silicon layer as a p-n junction or p-i-n junction photodiode.

Desirably, the detector is placed beneath the waveguide to detect cladding modes present in the waveguide.

Typically the detector is a photodetector and is placed or formed at the tip of the cantilever. Alternatively, the photodetector is placed near the root of the cantilever.

In a first embodiment the actuator is placed near the root of the cantilever. Typically the actuator is constructed as an electrothermal or electrostatic drive.

In one embodiment the actuator is an electrothermal shape bimorph actuator. In a first embodiment the waveguide is placed over the cold arm of such an electrothermal shape bimorph actuator.

In an alternative embodiment the electrothermal shape bimorph actuator has dual hot arms.

The electrical current in the cold arm is desirably monitored and suppressed using an active feedback circuit.

This is advantageous in reducing the pick up of un-wanted noise, with the effect that the lower the noise the greater the range of operation of the device.

The motion sensors are typically placed near the root of the cold arm and the root of the cantilever. This assists in maintaining the known scan amplitude which may otherwise be difficult to monitor. These may be constructed as piezo-resistive or capacitative devices or some other suitable type detector.

Typically, the motion sensors are constructed as pairs of piezo-resistors, arranged to detect differential strain caused by bending of the structure and may be connected to a differential readout circuit.

According to another embodiment of the present invention an optical reading system comprises a device having one or more of the following components:
1) a cantilevered single-mode optical waveguide suitable for transmitting light onto a target thereby illuminating the target and adapted to effect a reception of the back-scattered signal from the target into the cladding of the waveguide,
2) an actuator capable of achieving large in-plane displacement,
3) motion sensors capable of providing the necessary signals for closed loop control of the scan amplitude,
4) a cladding mode detector capable of implementing a confocal detection system so as to effect a detection of the light backscattered into the cladding of the waveguide
5) a lens, which may be formed in the wall of the device package, and the device being coupled to a laser source, which may be hybridised or integrally formed with the device of the present invention or linked thereto by a section of optical fibre so as to provide the incident light to the waveguide.

Desirably the elements 1-5 may all be fabricated in silicon-based materials using a compatible process. It will be appreciated that alternative materials such as gallium arsenide may also be considered as alternatives for the substrate material. This process also has the potential to allow the integration of the electronics for drive, sense and detection. The integration scheme of the present invention offers advantages of cost and size reduction, increased reliability, and improved optical and electrical performance.

Applications of the invention include miniature, portable or hands-free bar code readers for point-of-sale scanning, inventory control and video programming, and devices for inspection of confined spaces or similar medical applications such as endoscopy.

The present invention also provides a method of providing an optical reader comprising the steps of:
forming a detector in a substrate,
optically coupling a waveguide to the detector, and
effecting the formation of a cantilever coupled to the waveguide and adapted to effect a movement of the waveguide upon stimulation, and
   wherein the cantilever and detector are integrally formed in the substrate, the waveguide being adapted to transmit light onto a target and receive light backscattered from the target, the light received back into the waveguide being detectable using the detector.

These and other features of the present invention will be better understood with reference to the following drawings.

### BRIEF DESCRIPTION OF THE DRAWINGS

FIG. 1a shows a conventional bar code reader utilising scan by source motion,

FIG. 1b shows a conventional bar code reader utilising scan by source selection,

FIG. 1c shows a conventional bar code reader utilising scan by lens motion,

FIG. 1d shows a conventional bar code reader utilising scan by mirror deflection,

FIG. 1e shows a conventional bar code reader utilising scan by confocal detection,

FIG. 2a is a prior art moving fibre bar code reader utilising the generation of a scan line by a vibrating optical fibre cantilever,

FIG. 2b is a prior art moving fibre bar code reader which provides for the detection of back scattered light using a beam splitter as a tap,

FIG. 2c is a prior art moving fibre bar code reader which provides for the detection of back scattered light using a fibre coupler as a tap,

FIG. 3a is a ray model showing optical wave guidance in a dielectric waveguide,

FIG. 3b is a ray model showing a cladding mode in a dielectric waveguide,

FIG. 3c is a ray model showing cladding mode stripping in a dielectric waveguide,

FIG. 4 is an example of the principle behind a prior art dual numerical aperture moving fibre bar code reader,

FIG. 5a is a prior art MEMS actuator based on interdigitated electrostatic operation,

FIG. 5b is a prior art MEMS actuator based on buckling mode electrothermal operation,

FIG. 5c is a prior art MEMS actuator based on shape bimorph electrothermal operation,

FIG. 5d is a prior art MEMS actuator based on excitation of a cantilever resonator by a shape bimorph,

FIG. 6a shows a side and plan view of an arrangement of a waveguide, driver and detector for a supported waveguide according to the present invention,

FIG. 6b is side view of an arrangement of a waveguide, driver and detector for a supported waveguide with the substrate removed according to the present invention,

FIG. 6c shows a side and plan view of an arrangement of a waveguide, driver and detector for an unsupported waveguide according to the present invention,

FIG. 7a is a section along the line A-A of FIG. 6a showing an optical waveguide and cladding mode detector integrated into the substrate,

FIG. 7b is a section along the line B-B of FIG. 6c showing an externally attached waveguide,

FIG. 8a is a plan view of a cantilever tip,

FIG. 8b is a view of a circuit adapted to connect a photodiode to a transimpedance amplifier,

FIG. 9a is an arrangement of an integrated scanner incorporating an electrothermal shape bimorph drive with dual hot arms,

FIG. 9b is an integrated scanner having an arrangement of sensors and contact pads,

FIG. 10a shows drive electronics for an integrated scanner including a simplified drive arrangement with a floating source,

FIG. 10b shows an alternative arrangement with active suppression of the residual current in the cold arm,

FIG. 11a shows a plan view of a device according to the present invention showing the positioning of motion sensors near the actuator root,

FIG. 11b is a view showing the positioning near the cantilever root,

FIG. 11c shows an example of circuitry providing connection to readout circuit,

FIG. 12 shows a plan view of the routing for contact metallisation,

FIG. 13 is a process flow shows steps associated with the formation of a device according to the present invention, and

FIG. 14 details in successive steps more detail associated with the manufacture of an integrated device according to the present invention.

### DETAILED DESCRIPTION OF THE INVENTION

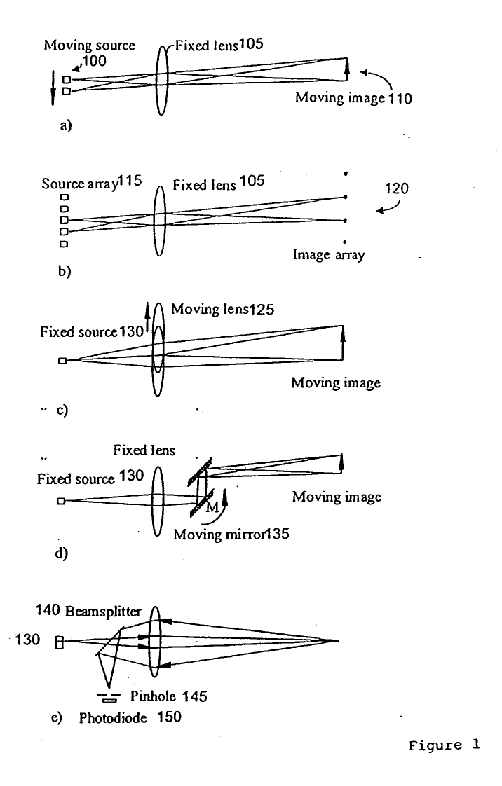

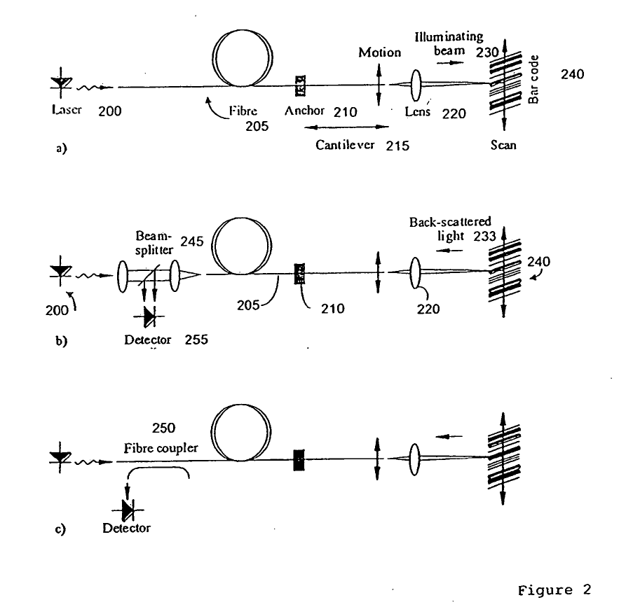

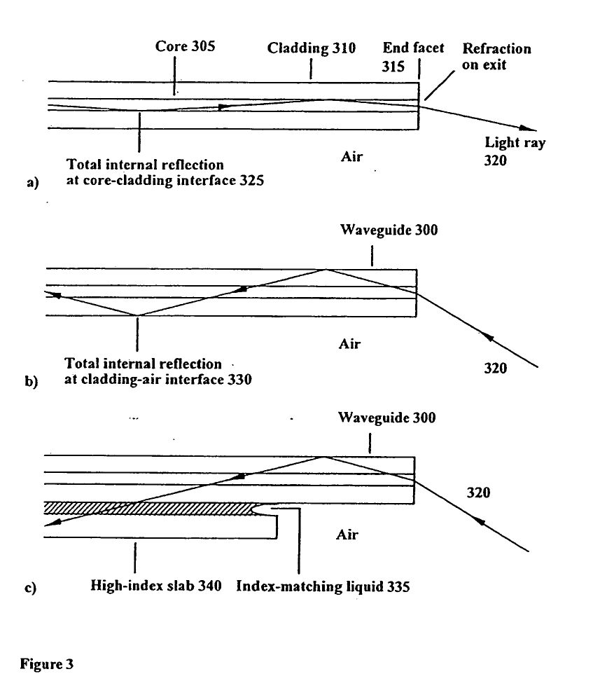

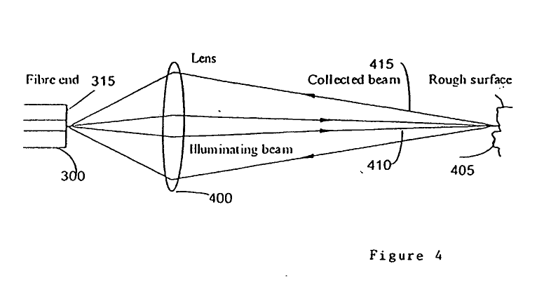

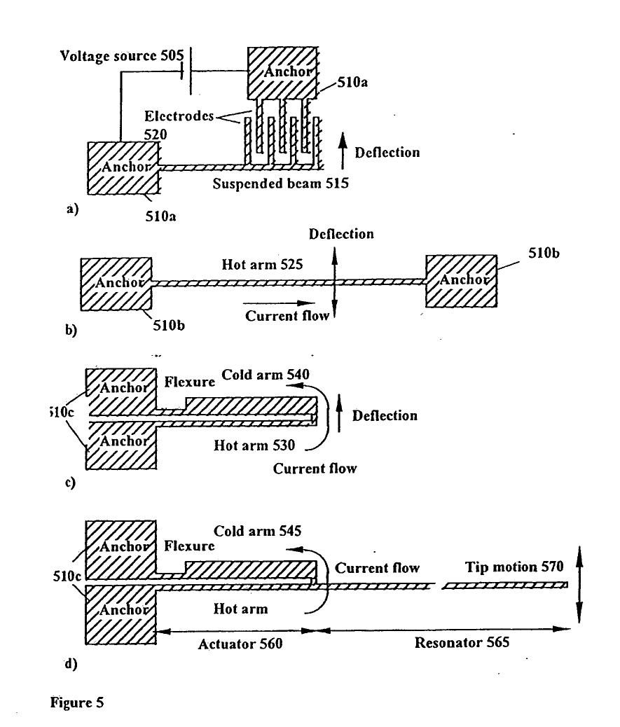

FIGS. 1 to 5 have been described previously with reference to prior art implementations.

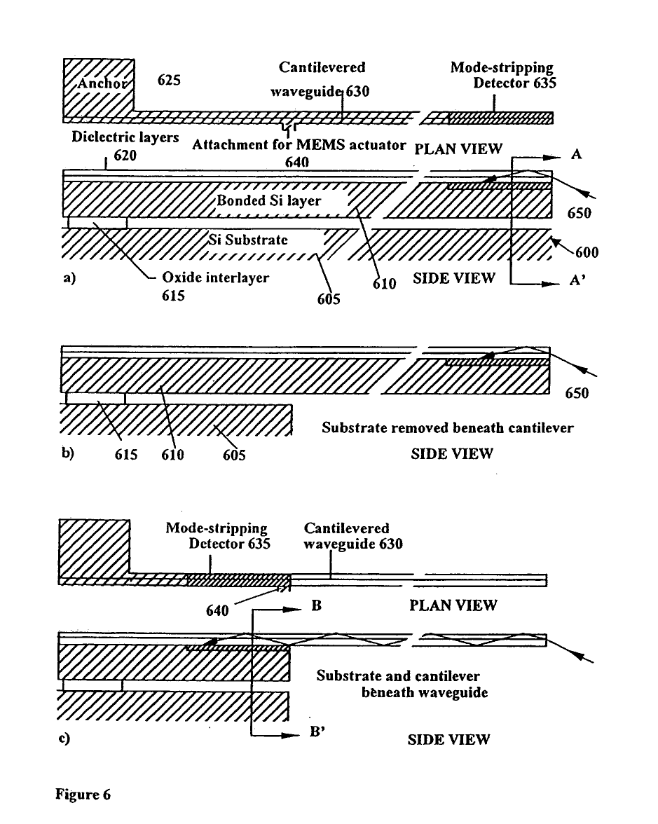

The present invention will now be described with reference to FIGS. 6 to 14.

FIG. 6 shows an integrated optical reader according to the present invention. The optical detection device provides an actuator (640) for effecting movement of a optical waveguide (630) and a detector (635) for detecting the light, which is predominately backscattered light. Both are integrally formed in a substrate (605). In a preferred embodiment a movement of the waveguide is provided by coupling the waveguide to a cantilever and actuating the cantilever to effect an associated movement of the waveguide. Desirably the detector is adapted to detect the cladding mode components of a waveguide. Preferably these components of the optical detection device are combined with a light source, a waveguide and motion detectors.

We now give a detailed description of the invention, considering in turn aspects of the source, waveguide and cantilever, cladding mode detector, actuator and motion sensors.

We first consider the source. We assume for the purposes of pointing the device that a visible source is required, although it will be appreciated that the source can be chosen dependent on the application of the device. To obtain sufficient power coupled into the waveguide, the source will typically be a laser constructed in III-V materials with an appropriate bandgap. It will be appreciated by the person skilled in the art that either a conventional stripe waveguide laser or a vertical cavity surface emitting laser (VCSEL) will typically be most suitable. Known techniques exist for attaching an optical fibre pigtail to either type of laser. The fibre pigtail may be used directly as the waveguide element of the scanner, as described later.

Alternatively, the fibre pigtail may be butt-coupled to a different optical waveguide that forms an integral part of the scanner. Finally, an un-pigtailed laser may be butt coupled to an integrated waveguide, and attached to the substrate by flip-chip bonds.

We now consider the integrated parts of the device. Because silicon itself is not transparent at visible wavelengths, the waveguide must be formed from other materials. These materials must be of sufficient thickness that the guided light is held away from any regions supported by a silicon substrate, so that optical propagation losses remain low. Suitable transparent, silicon compatible materials include but are not limited to Si₃N₄, SiO₂, silicate glasses (i.e., SiO₂ doped with compatible oxides), and other deposited oxides. Suitable deposition processes for these materials include vacuum evaporation, sputtering, chemical vapour deposition (CVD), plasma enhanced chemical vapour deposition (PECVD), flame hydrolysis deposition (FHD) and the sol-gel process.

It will be appreciated that not all processes can achieve large deposited thickness. Thin dielectric layers may still be used, provided the refractive index step between the core and the cladding is sufficiently large that the guided mode is confined well away from the substrate.

If thin layers are used, the waveguide must be supported by an additional mechanical structure along its entire length. A suitable structure can be provided using bonded silicon-on-insulator (BSOI) material. BSOI consists of an oxidised silicon substrate, to which is bonded a second silicon substrate. The bonded substrate may then be polished back to leave a desired thickness of silicon. Other methods of constructing similar substrates exist. The upper silicon layer may be patterned and etched to define mechanical and other parts, using standard MEMS processes. The oxide layer may then be removed from beneath the mechanical parts to allow motion.

Using BSOI material and suitable dielectric layers, a waveguide cantilever (630) having a mechanical support along its entire length may be constructed as shown in FIG. 6a.

The bonded silicon layer (610) provides the support, and the oxide interlayer (615) is removed from beneath the cantilever (630) except at the anchor (625) to allow motion.

Because the deposited dielectric layers (625) are often stressed, the cantilever may be distorted from the ideal straight, linear geometry. If the dielectric layers are under compressive stress, it may be deflected downward towards the substrate. In this case, the substrate (605) may be removed from beneath the cantilever as shown in FIG. 6b. This geometry allows additional clearance, and the possibility of depositing additional layers of dielectric on the base of the cantilever to apply a counterbalancing stress.

The bonded layer (610) may also be removed from beneath the waveguide (630), as shown in FIG. 6c, so that the majority of the suspended structure is a free-standing dielectric cantilever without an additional mechanical support. A similar geometry is provided by attaching a separate dielectric waveguide (750) (such as an optical fibre) to suspended MEMS parts (for example, using index-matched epoxy).

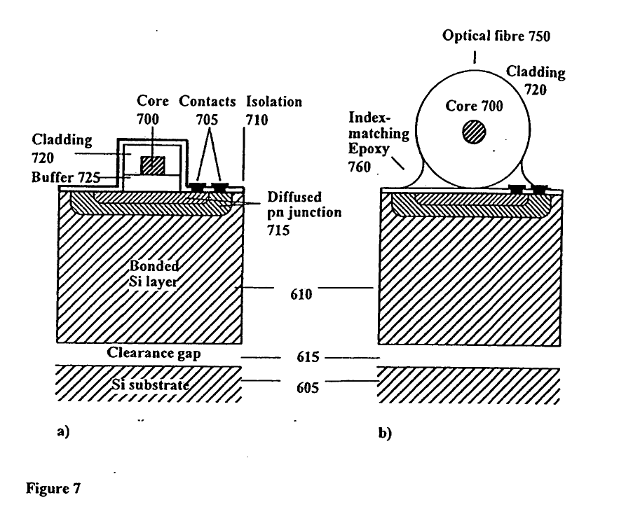

An integrated dielectric optical waveguide is desirably formed as a three-layer structure as shown in FIG. 7a. The three layers comprise:
1) A buffer layer (725) of lower index dielectric, which isolates the guided mode from the silicon substrate,
2) A core (700) of higher-index dielectric, which is etched into a cross-section of dimensions suitable for single-mode operation
3) A cladding (720) of lower-index dielectric, which is deposited over the patterned core.

After deposition of the cladding layer, the whole structure is etched down to the silicon surface to provide a cladding of defined lateral dimension. The lateral dimension will typically be large enough to isolate the guided mode from the edge of the cladding. However, it will not be so large as to increase the area from which back-scattered light is gathered by an unwarranted amount.

Alternatively, in a hybrid integrated device, the waveguide may be provided externally (for example, as an optical fibre pigtail (750)) and attached to the other MEMS parts using index-matching epoxy (760) as shown in FIG. 7b.

In order to avoid interference effects between different modes of propagation, the waveguide is desirably single-moded. However, even single-mode waveguides support two different modes, one for each possible polarization of light. Interferometric effects may still arise if both polarization modes are launched, and if the motion of the waveguide gives rise to time-varying phase shifts between them. For this reason, the waveguide is therefore desirably asymmetric, so that the two polarization modes are distinct. It is also desirable that the source is polarized, and has its polarization axis orientated such that only one polarization mode is coupled into the waveguide.

The cladding mode detector (715) may be a p-n or p-i-n photodiode, formed in the bonded silicon layer using standard methods of in-diffusion of p- and n-type dopants, and arranged to lie beneath the dielectric waveguide as shown in FIG. 7a. Although silicon is not a direct gap material, such a detector will be entirely appropriate for visible light.

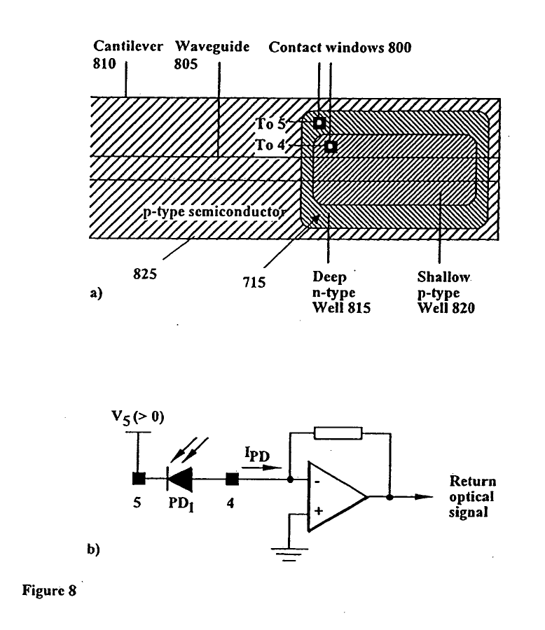

For example, the support cantilever (805, 810) may be fabricated in p-type semiconductor (825), as shown in FIG. 8a. A p-n photodiode may then be formed in this layer, by first creating a deep n-type well (815) and then a shallow p-type well (820). An additional isolation layer (710, in FIG. 7) of lower-index dielectric may be deposited over the waveguide (805) and etched to provide via holes through to the p-well and the n-well.

Contact metallisation (800) may then be deposited and patterned to allow ohmic connection to the detector (715). The contact tracks may be taken along the cantilever to its root for connection to suitable electronics. The photodiode current I_{PD} may be detected using a transimpedance amplifier circuit, as shown in FIG. 8b. Here a positive DC bias V₅ is applied to the contact to the n-well (815), to maintain the photodiode (PD1) under reverse bias.

If the cantilever (810) potential is held near to ground, the p-n diode formed between the n-well (815) and the cantilever will also be under reverse bias, thus providing effective electrical isolation between the photodiode and the cantilever. This isolation will also apply to the other sensor components, as described later.

Because the presence of a silicon substrate beneath the dielectric waveguide will result in the rapid absorption of cladding mode light, the optimum position of the cladding mode detector is different in the geometries of FIGS. 6a and 6c. In FIG. 6a, the cladding mode detector (635) must lie at the tip of the cantilever. In FIG. 6c, it must lie near the root. This choice of positioning of the detector (635) is effected based on the structure of the device. However, cladding light will still be directed along the waveguide to the detector by total internal reflection at the cladding-air interface.

To obtain sufficient lateral deflection, the waveguide is typically arranged as a long, relatively massive cantilever, driven at its root by an actuator (640). Because they simply require the fabrication of additional etched features, electrostatic and electrothermal MEMS actuators may each be integrated with the suspended cantilever very simply.

In the case of an electrostatic actuator, an interdigitated electrode structure is most suitable. The waveguide should ideally be mounted above the grounded arm, to miniinise the effect of voltage fluctuations.

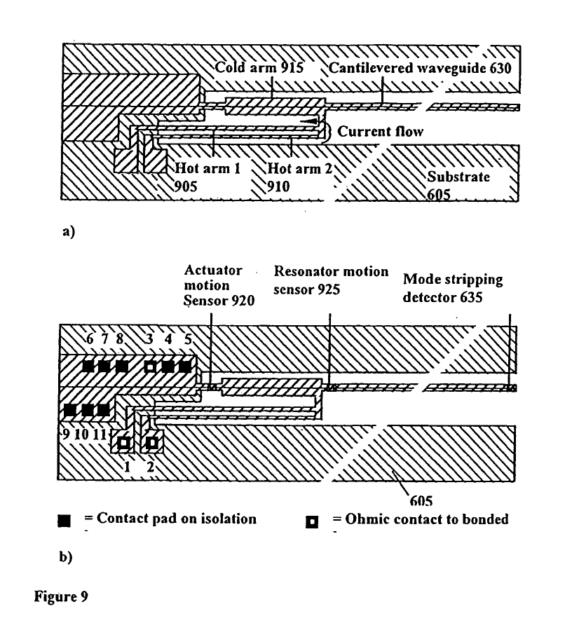

In the case of an electrothermal actuator, a shape bimorph is most suitable, as it induces bending and therefore can be used to effect better actuation of the cantilever and associated waveguide. As shown in FIG. 9, the waveguide (630) should ideally be mounted above the cold arm (915), to minimise the effect of temperature variations. To reduce the heating of the cold arm as much as possible, the actuator then desirably has a dual hot arm (905, 910) as shown in FIG. 9a. The heating current is passed between the terminals 1 and 2 of the two hot arms in FIG. 9b so that direct resistive heating of the cold arm is avoided.

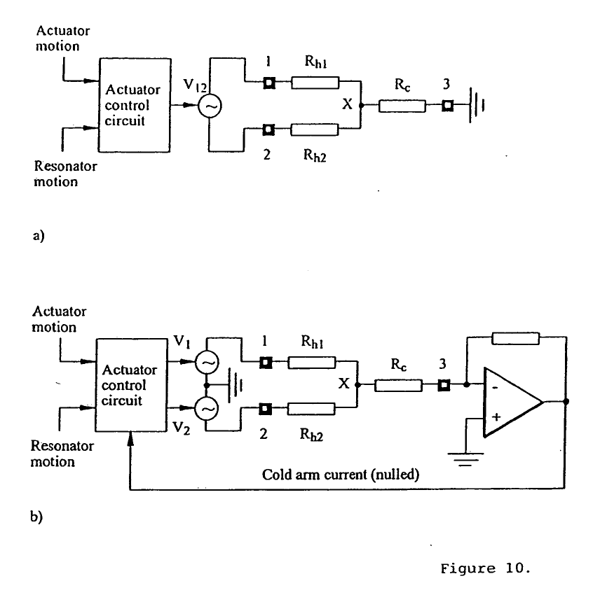

In order to reduce electrical cross-talk between the drive and the various sensors, the potential of the cold arm should be held as close to ground as possible. The terminal 3 to the cold arm may be grounded, and the actuator may be driven using a floating voltage source V₁₂ as shown in FIG. 10a. Rₕ₁ and Rₕ₂ are the resistances of the two hot arms.

If there are no parasitic currents, then no current will flow through the resistance R_{c} of the cold arm and the cold arm will be at ground. In general, it will be appreciated however that, there will be parasitic current paths to ground, both from the source and from the circuit elements. These may lead to a small residual current in R_{c} and hence an unwanted AC voltage in the cold arm. The amplitude of this voltage will vary along the cold arm from zero at terminal 3 to a maximum at point X, remaining at this amplitude along the cantilever. This voltage may be coupled undesirably to the sensor elements (920, 925).

In over to overcome such variances it is possible to modify the drive, an example of which is shown in the improved drive of FIG. 10b. Here the residual current in the cold arm is monitored by a transimpedance amplifier connected to terminal 3, and actively suppressed by a closed loop controller using two separate AC voltage sources V₁ and V₂.

To establish a closed-loop control of the scan amplitude, the mechanical motion of the actuator and the cantilever must be monitored. A measure of the actuator and cantilever deflection may be obtained by using piezo-resistive or capacitative sensors. The former may be integrated during one of the diffusion steps used to fabricate the photodiode, and the latter during construction of the actuator.

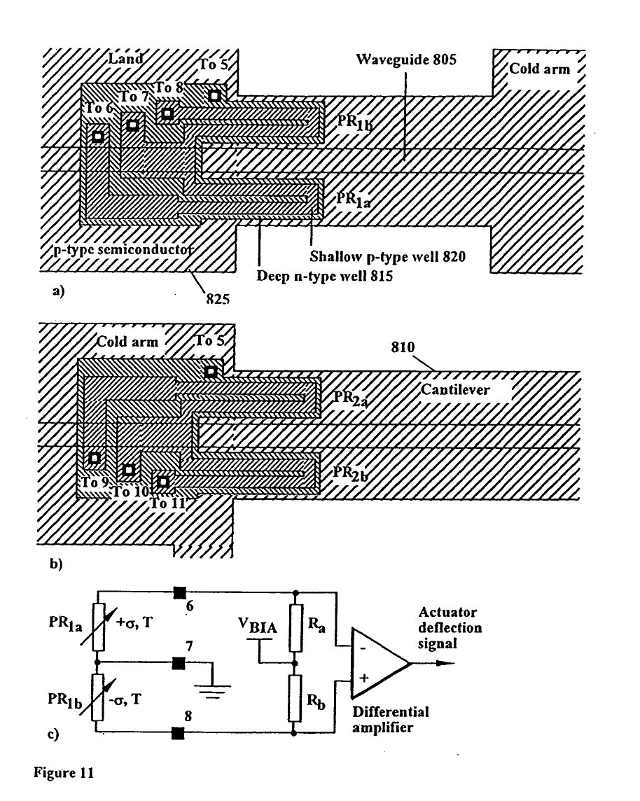

FIG. 9b shows suitable locations for piezo-resistive sensors, at the root (920) of the cold arm and the cantilever (925). FIGS. 11a and 11b show how these sensors may be constructed as p-type resistive channels (PRIb, PRia, PR₂ₐ, PR_{2b}) in an n-type well formed in a p-type layer, using similar diffusion processes as FIG. 8a.

In order to minimise the sensitivity to temperature, two piezo-resistors are used at each location. At the root of the cold arm, the piezo-resistors are PR₁ₐ between contacts 6 and 7, and PR_{1b} between contacts 7 and 8. At the root of the cantilever the piezo-resistors are PR₂ₐ between contacts 9 and 10, and PR_{2b} between contacts 10 and 11.

At each sensor location, the two piezo-resistors experience similar temperatures T. However, because they are located near opposite edges of the mechanical structure, they experience opposite stresses when the structure is bent laterally. The common mode signal caused by temperature variations may therefore be rejected in favour of the signal due to bending, by using a differential readout.

A suitable differential readout circuit for the actuator motion sensor may be based on a resistive bridge, as shown in FIG. 11c. The circuit required for the cantilever motion sensor is similar. In this configuration, equal bias currents are applied to the two piezo-resistors using a bias voltage VBIAS and series resistors Rₐ and R_{b}. The difference between the resulting voltages is measured using a differential amplifier.

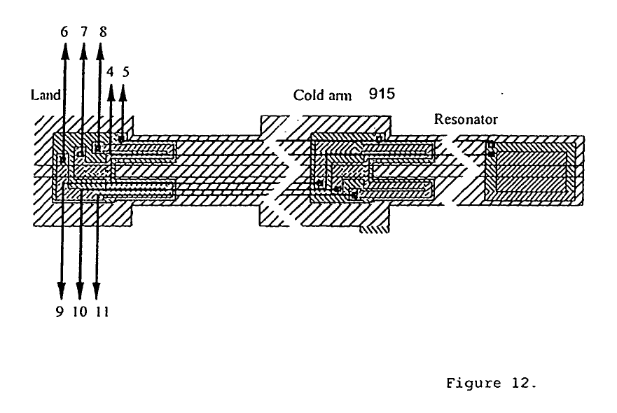

In the complete system, electrical contacts are taken to the electrothermal drive (from terminals 1, 2 and 3), the photodetector (from terminals 4 and 5), the actuator motion sensor (from terminals 6, 7 and 8), and the cantilever motion sensor (from terminals 9, 10 and 11). The first three contacts are made directly to the bonded silicon layer. The remainder should typically be routed to their relevant locations using patterned metal tracks. FIG. 12 shows a simple arrangement for routing the contact metallisation on either side of the waveguide.

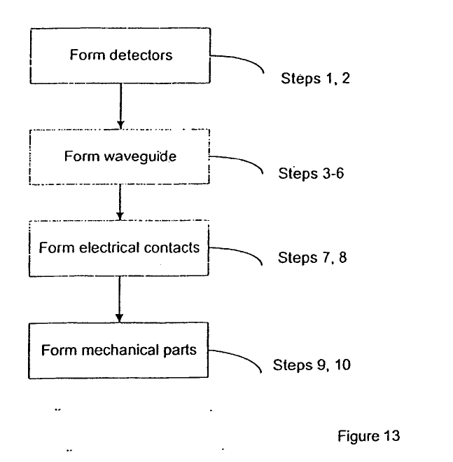

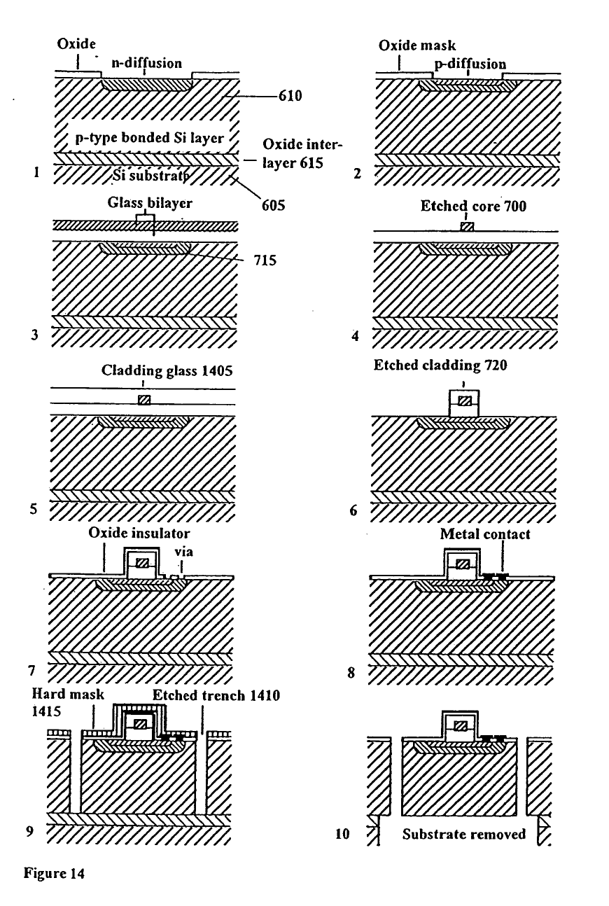

FIG. 13 is a simplified process flow to be read in combination with FIG. 14 and outlines the process flow according to one embodiment of the present invention for forming a device according to the present invention. In steps 1 and 2 of FIG. 14 the detectors are formed in the silicon substrate. Steps 3-6 are concerned with the formation of a waveguide in the substrate. Steps 7 and 8 relate to the formation of electrical contacts to external drive and sensing circuitry whereas Steps 9 and 10 relate to an etch process which is undertaken so as to form the cantilever. These steps are outlined in more detail in FIG. 14 which shows an example of a wafer-scale process for fabrication of a set of dies, each comprising an integrated scanner containing the elements described above. The starting material is a bonded silicon-on-insulator wafer with a p-type bonded Si layer. Variations of the processes shown, and also of the exact sequence in which they are performed, may be used to create similar structures, as will be appreciated by those skilled in the art and it is not intended to limit the process flow of the present invention to any specific sequence or operation of steps.

The p-n junction photodetectors and piezoresistors are formed in Steps 1 and 2. In Step 1, the wafer is oxidised, and the first oxide layer is patterned by lithography and then etched to provide openings for all the n-wells. The n-wells are desirably formed by a deep diffusion, and the first oxide mask is removed. In Step 2, the wafer is re-oxidised, and the second oxide layer is patterned by lithography and then etched to provide openings for all the p-wells. The p-wells are formed by a shallow diffusion, and the second oxide mask is removed.

The waveguides are formed in Steps 3-6. In Step 3, a glass bilayer is deposited on the wafer. The glass compositions are chosen so that the upper layer has a higher refractive index than the lower layer, so that a waveguide is formed. The thickness of the upper glass layer is chosen so that it can act as the core of a single mode buried channel guide. The thickness of the lower glass layer is chosen so that the evanescent field of the guided mode has decayed sufficiently by the time it reaches the bonded silicon layer that low propagation loss may be obtained. In Step 4, the upper glass layer is patterned by lithography and then etched into narrow strips, which can act as the cores of buried channel guides. In Step 5, a further glass layer is deposited on the wafer. The glass composition is chosen so that it has a lower refractive index than the core glass, and can therefore act as a cladding for the cores. In Step 6, the wafer is patterned by lithography and then etched to remove the cladding and buffer layer glass from everywhere except in narrow strips surrounding each buried core.

The electrical contacts are formed in Steps 7 and 8. In Step 7, a further glass layer is deposited on the wafer. This layer may be similar to the cladding glass; however, it now has the function of electrical isolation. This layer is patterned by lithography and then etched to provide windows through which electrical contact may be made to the diffused wells, and also to the bonded silicon layer itself. In Step 8, metal layers suitable for making ohmic contacts to the diffused wells and to the bonded silicon layer itself are deposited over the wafer. These layers are patterned by lithography and then etched to form a set of connecting tracks.

The mechanical parts are formed in Steps 9 and 10. In Step 9, a layer of durable material is deposited over the wafer. This layer is lithographically patterned, and then used as a hard mask in a deep etching step. In this step, trenches are etched right through the bonded silicon layer, to define the mechanical parts of the structure. One suitable process for this step would be deep reactive ion etching using an inductively coupled plasma etcher. The hard mask is then removed. In Step 10, the rear of the wafer is removed from beneath the movable mechanical parts, together with the oxide interlayer. One suitable process for this step would be deep reactive ion etching from the rear of the wafer.

Following these processes, the wafer is separated into individual dies, each containing a scanner component. The dies are individually packaged, and wirebond connections are made to the electrical contact pads. Depending on the exact mode of operation, a laser source is then either coupled directly to the channel waveguide or coupled indirectly using a linking section of optical fibre.

Accordingly the present invention provides a microengineered optical scanner based on a moving cantilevered dielectric waveguide. The waveguide is typically excited into resonant mechanical motion by a drive, desirably located at its root. Stress sensors may be provided to detect the bending of the waveguide, thereby allowing closed loop control of the motion. A moving image of the light emitted from the moving tip of the waveguide is created by a lens. The moving image acts as a scan line. Light back-scattered from a rough surface placed at the image plane is collected back into the waveguide by confocal imaging. The light collected in the cladding of the waveguide has a higher numerical aperture than the light collected in the core. The cladding light is detected by a mode-stripping detector. As such, the system of the present invention provides a dual numerical aperture confical detection system. Techniques for combining a cantilevered waveguide, a drive, motion sensors and a mode-stripping detector using microelectromechanical systems (MEMS) technology are described.

The device of the present invention provides for a cantilevered waveguide, transducer, detector and electronics to be combined using silicon-based MEMS technology. This integration of the main system components provides for the construction of a cheap, reliable bar code reader based on these principles. Because silicon is not a direct gap material, the source cannot be integrated. However, it may be added by hybrid integration of a discrete laser in III-V materials. Generally, the source will emit visible light to allow the scanner to be pointed by eye.

It will be appreciated that components of the present invention have been shown and described in specific combination with one another. It is not intended to limit the present invention to any one specific combination and it will be appreciated that any one component may be taken and combined with any other component without departing from the spirit and scope of the present invention. It is not intended to limit the present invention except as may be required in the light of the appended claims.

The words “comprises/comprising” and the words “having/including” when used herein with reference to the present invention are used to specify the presence of stated features, integers, steps or components but does not preclude the presence or addition of one or more other features, integers, steps, components or groups thereof.

1. An optical reading device having a light source, a movable optical waveguide, an actuator, a detector, and wherein the actuator and detector are integrally formed in a substrate, the movement of the waveguide being effected by action of the actuator thereon, and wherein the detector provides a confocal detection system adapted to effect a detection of light backscattered into cladding of the waveguide.

2. The device as claimed in claim 1 further including at least one motion sensor such that any movement of the waveguide is detectable by the motion sensors.

3. The device as claimed in claim wherein the optical waveguide is formed as an integrated channel guide formed in dielectric materials and surrounded by a cladding of restricted lateral dimensions.

4. The device as claimed in claim 1 wherein the waveguide may be externally attached or coupled to the device.

5. The device as claimed in claim wherein the optical waveguide is single-moded and polarization-preserving.

6. The device as claimed in claim wherein the source is polarized and arranged to excite a single polarization mode of the waveguide.

7. The device as claimed in claim wherein the optical waveguide is positioned on a suspended cantilever above a substrate.

8. The device as claimed in claim 7 wherein the waveguide is supported by a mechanical layer along its entire length.

9. The device as claimed in claim 7 wherein the waveguide has a root and is supported only near its root by a mechanical layer.

10. The device as claimed in claim wherein the actuator and detector are integrally formed in a silicon based layer.

11. The device as claimed in claim 10 wherein the detector is constructed in the silicon layer as a p-n junction or p-i-n junction photodiode.

12. The device as claimed in claim wherein the detector is placed beneath the waveguide to detect cladding modes present in the waveguide.

13. The device as claimed in claim 7 wherein the detector is a photodetector and is placed or formed at the tip of the cantilever.

14. The device as claimed in claim 7 wherein the photodetector is placed near the root of the cantilever.

15. The device as claimed in claim 7 wherein the actuator is placed near the root of the cantilever.

16. The device as claimed in claim 15 wherein the actuator is constructed as an electrothermal or electrostatic drive.

17. The device as claimed in claim 16 wherein the actuator is an electrothermal shape bimorph actuator.

18. The device as claimed in claim 17 wherein the waveguide is placed over a cold arm of the electrothermal shape bimorph actuator.

19. The device as claimed in claim 16 wherein the electrothermal shape bimorph actuator has dual hot arms.

20. The device as claimed in claim 18 wherein electrical current in the cold arm is monitored and suppressed using an active feedback circuit.

21. The device as claimed in claim 17 wherein the motion sensors are placed near the root of the cold arm and the root of the cantilever.

22. The device as claimed in claim 21 wherein the motion sensors are constructed as pairs of piezo-resistors, arranged to detect differential strain caused by bending of the structure and connected to a differential readout circuit.

23. An optical reading system comprising a device having at least one of the following components:
a) a cantilevered single-mode optical waveguide suitable for transmitting light onto a target thereby illuminating the target and adapted to effect a reception of the back-scattered signal from the target into the cladding of the waveguide,
b) an actuator capable of achieving large in-plane displacement,
c) motion sensors capable of providing the necessary signals for closed loop control of the scan amplitude,
d) a cladding mode detector capable of implementing a confocal detection system so as to effect a detection of the light backscattered into the cladding of the waveguide,
e) a lens, which may be formed in the wall of the device package, the device being coupled to a laser source, which may be hybridised or integrally formed with the device of the present invention or linked thereto by a section of optical fibre so as to provide the incident light to the waveguide.

24. The system as claimed in claim 23 wherein the elements a) through e) are all fabricated in silicon-based materials using a compatible process.

25. A method of forming an optical reader comprising the steps of:
a) forming a detector in a substrate,
b) forming an actuatable cantilever also in the substrate,
c) coupling a waveguide to the cantilever, and
wherein the cantilever and detector are integrally formed in the substrate, the waveguide being adapted to transmit light onto a target and receive light backscattered from the target, the light received back into the waveguide being detectable using the detector.
